(19) United States
(12) Patent Application Publication
(10) Pub. No.: US 2025/0096286 A1
(43) Pub. Date: Mar. 20, 2025

(54) MEMBRANE STACKING UNIT

(71) Applicant: MAHLE International GmbH, Stuttgart (DE)

(72) Inventors: Tobias Baumgart, Winterbach (DE); Stefan Moedinger, Remseck a.N. (DE); Samuel Kohler, Weil im Schoenbuch (DE); Alexander Jerger, Sachsenheim (DE)

(21) Appl. No.: 18/890,739

(22) Filed: Sep. 19, 2024

(30) Foreign Application Priority Data
Sep. 19, 2023 (DE) 10 2023 209 088.0

(51) Int. Cl. H01M 8/04119; B01D 63/08; H01M 8/04828

(52) U.S. Cl. CPC H01M 8/04149; B01D 63/0822; B01D 63/085; H01M 8/04141; H01M 8/04835; H01M 8/04843; B01D 2313/10; H01M 2250/20

(57) ABSTRACT

A membrane stacking unit for a humidifier for a vehicle powered by fuel cells is disclosed. The membrane stacking unit includes a cuboid membrane stack with a plurality of flexible membranes stacked in a stacking direction, with four side faces through which air can flow and two end faces through which air cannot flow. Two sealing frames are assigned to two opposing side faces of the membrane stack. The respective sealing frame has a circumferential sealing region and a circumferential region projecting vertically. The respective sealing frame has a recess that is filled with an adhesive for sealing to the membrane stack.

### CROSS-REFERENCE TO RELATED APPLICATION

This application claims priority to German Application No. DE 10 2023 209 088.0 filed on Sep. 19, 2023, the contents of which are hereby incorporated by reference in its entirety.

### TECHNICAL FIELD

The invention relates to a membrane stacking unit for a humidifier for a vehicle powered by fuel cells. The invention also relates to the humidifier with the membrane stacking unit.

### BACKGROUND

For example, a humidifier can be used in a fuel cell system to humidify dry air flowing to the fuel cell with humid air flowing from the fuel cell. The humidifier usually comprises a housing and a membrane stack consisting of several flexible membranes. The membranes in the membrane stack are stacked at a distance from each other and glued together in such a way that four side faces of the membrane stack are connected to each other in pairs in an air-conducting manner and separated from other side faces in an airtight manner. This allows the dry air and the humid air to flow through the membrane stack in a cross flow and exchange humidity or water vapor with each other via the membrane. To prevent the dry air and humid air from mixing in the humidifier, the side faces through which the air can flow must be separated from each other in an airtight manner. Usually, a rectangular and frame-like frame is used for this purpose, which is glued to the side faces of the membrane stack. The membrane stack and the frame together form a so-called membrane stacking unit, which is then arranged in the housing. The frame is glued to the membrane stack after the membrane stack has been installed in the frame and can be very time-consuming.

The task of the invention is therefore to provide an improved or at least alternative embodiment for a membrane stacking unit of the type according to the invention, in which the disadvantages described are overcome. The task of the invention is also to provide a corresponding humidifier with the membrane stacking unit.

According to the invention, this problem is solved by the scope of the independent claim(s). Advantageous embodiments are the subject of the dependent claims.

### SUMMARY

The present invention is based on the general idea of forming the frame in several parts and at least from two frame plates and introducing an adhesive groove into the frame plates so that assembly can be simplified.

The membrane stacking unit according to the invention is intended or designed for a humidifier for a vehicle powered by fuel cells. The membrane stacking unit has a cuboid membrane stack with several flexible membranes stacked in a stacking direction. The membrane stack has four side faces through which air can flow and which are aligned parallel to the stacking direction and two end faces through which air cannot flow and which are aligned transverse to the stacking direction. The membrane stacking unit also has two sealing frames and the sealing frames are assigned to two opposing side faces of the membrane stack. The respective sealing frame has a circumferential sealing region and a circumferential region that protrudes vertically from the sealing region. The sealing region runs around the edge of the respective assigned side face and rests against it. The circumferential region faces the membrane stack and runs around the edge of the membrane stack. According to the invention, the respective sealing frame has, at least on a surface of the sealing region facing the assigned side face, a recess running around the assigned side face. The respective recess is filled with an adhesive and the respective sealing frame is glued to the membrane stack via the adhesive.

The membrane stack can be formed from several flexible membranes, wherein the individual membranes are arranged at a distance from each other. The membranes can be designed in such a way that they are impermeable to air and permeable to humidity and water vapor. Flow-through spacers or so-called spacers can be stacked between the membranes. The membrane and the spacers can be glued together in such a way that ducts through which air can flow are formed between the membranes. The respective ducts can connect two of the respective opposite side faces of the membrane stack in an air-conducting manner and be separated from two other of the respective opposite side faces of the membrane stack in an airtight manner. The individual ducts can alternately connect the respective opposite side faces in the stacking direction so that air can flow through the membrane stack as a whole in a cross flow.

The four side faces through which air can flow and the two end faces through which air cannot flow delimit the membrane stack to the outside or form the outer face of the cuboid membrane stack. The two end faces are arranged opposite each other and can be formed by the last membranes in the stacking direction. Alternatively, the membrane stacking unit can have two sealing plates, wherein the sealing plates can rest on the respective last membranes in the stacking direction and, in particular, can be sealed to the respective last membranes in the stacking direction. The sealing plates can then be identical in surface area to the last membranes in the stacking direction and reproduce the end faces of the membrane stack. The sealing plates can, for example, be made of plastic and, in particular, be glued to the last membrane in the stacking direction.

The membrane stacking unit has two—in particular exactly two—sealing frames. The respective sealing frame is formed from the sealing region and the circumferential region. The sealing region and the circumferential region can be integrally formed to each other or merge integrally into each other or be inseparably connected to each other. The sealing region can be formed by a flat or even frame. The sealing region can have an edge on the inside and the circumferential region can be formed on the outside or opposite the edge. The circumferential region is shaped perpendicular to the sealing region. As a result, the sealing frame can have an L-shaped cross-section in particular. The sealing region is in contact with the respective assigned side face of the membrane stack. The circumferential region runs around the edge of the membrane stack and is arranged perpendicular to the assigned side face or parallel to all faces of the membrane stack adjacent to the assigned side face—i.e. to the two end faces and the two adjacent side faces. The sealing frame can be molded from plastic, for example.

The recess for the adhesive is formed on the surface of the sealing region facing the assigned side face. The respective sealing frame is then glued to the membrane stack via the adhesive. The recess is formed all the way around the sealing frame and can completely encircle the assigned side face. In particular, the recess can follow the frame-like shape of the sealing region. The adhesive can be any adhesive that is liquid or flowable and solidifies after application with or without additional treatment—i.e. treated or untreated. When fitting the sealing frame to the membrane stack, the adhesive can be applied to the recess and then the sealing frame can be glued to the membrane stack. A sufficient amount of adhesive can be applied through the recessed groove, thereby ensuring reliable adhesion of the sealing frame to the membrane block.

In one possible embodiment of the membrane stacking unit, the respective recess can be formed by a groove. In particular, the groove can be formed at a distance from an edge of the sealing region opposite the circumferential region. The groove can completely encircle the assigned side face and be arranged at a distance from an edge of the sealing region opposite the circumferential region. The groove can also be arranged at a distance from the circumferential region. In other words, the groove can be delimited from the edge of the sealing region and/or from the circumferential region by a web. The groove is formed on the respective surface of the sealing region and can protrude into the sealing region. This allows the groove to absorb a sufficient amount of adhesive and the sealing frame can be securely connected or glued to the membrane stack. The groove itself can have any cross-section. In particular, the groove can have a U-shaped cross-section.

In a possible further embodiment of the membrane stacking unit, the respective recess can be formed by a groove open on one side. The groove can then be delimited from an edge of the sealing region opposite the circumferential region by at least one web and be open to the circumferential region. In other words, the groove can be arranged at a distance from an edge of the sealing region opposite the circumferential region. The groove, which is open on one side, allows the excess adhesive to drain to the circumferential region and further into a gap formed between the circumferential region and the membrane stack. This allows the adhesive to spread freely between the membrane stack and the sealing frame and makes it easier to dispense the adhesive. Furthermore, the excess adhesive can be prevented from leaking onto the assigned side face and thus blocking the air ducts.

The respective sealing frame can have at least one drainage groove for draining the excess adhesive from the recess. The drainage groove can be fluidically connected to the recess and lead from the respective recess to an edge of the sealing region opposite the circumferential region and thus to the side face of the membrane stack. Alternatively, the drainage groove can be fluidically connected to the recess and lead from the respective recess to the circumferential region of the sealing frame and thus to a gap between the membrane stack and the circumferential region. The respective drainage groove can be aligned perpendicular to the respective recess, for example. The excess adhesive can be drained from the recess via the respective drainage groove, enabling the sealing frame to be securely glued to the assigned side face. In order to remove the excess adhesive evenly from the recess, several drainage grooves can be provided, which may or may not be evenly distributed around the circumferential recess. The multiple drainage grooves can be identical or different in shape.

In one possible embodiment of the membrane stacking unit, the respective sealing frame can have at least one overflow groove running around the assigned side face. The overflow groove can be formed at a distance from the recess on the surface of the sealing region facing the assigned side face and be fluidically connected to the recess. The overflow groove can advantageously absorb the excess adhesive without the adhesive getting onto the assigned side face.

The respective overflow groove can, for example, be located between the recess and an edge of the sealing region opposite the circumferential region. Alternatively, the respective overflow groove can be located between the recess and the circumferential region of the sealing frame. It is understood that the respective sealing frame can also have two overflow grooves that differ from or are identical to each other. The overflow grooves can then be formed on both sides of the respective recess in the form of a groove.

The respective recess and the respective overflow groove are fluidically connected to each other. For this purpose, a web formed between the recess and the overflow groove can be spaced from the assigned side face, thereby forming a gap between the web and the assigned side face. The respective recess and the respective overflow groove can then be fluidically connected to each other via the gap. Alternatively or additionally, at least one connecting groove can be formed in a web formed between the recess and the overflow groove. The recess and the respective overflow groove can then be fluidically connected to each other via the respective connecting groove.

In one possible embodiment of the membrane stacking unit, it may be provided that the respective recess has at least two sections with different heights and/or different widths. In other words, the respective recess can vary in height and/or width along its longitudinal axis. As a result, the respective sealing frame can be glued to the assigned side face or to the membrane stack in different sections with a different amount of adhesive. Similarly, the respective overflow groove can have at least two sections with different heights and/or different widths. In other words, the respective overflow groove can vary in height and/or width along its longitudinal axis. The design of the overflow groove can be suitably adapted to the design of the recess or vice versa.

When manufacturing the membrane stacking unit, the membrane block can be produced in a first step. For this purpose, the membranes and the flow-through spacers are glued together and the sealing plates are placed on the last membranes in the stacking direction. The sealing plates can remain loosely placed on the last membranes in the stacking direction or alternatively be glued to the last membranes in the stacking direction. This allows the rectangular membrane block to be produced with the four side faces through which air can flow and the two end faces through which air cannot flow. In a second step, the membrane stack can be pre-tensioned and glued to the two sealing frames. For this purpose, the adhesive can be dispensed into the respective recess of the respective sealing frame in advance and then the respective sealing frame can be glued to the respective assigned side face. The respective recess can be overfilled so that the respective sealing frame and the membrane stack can be connected to each other without blowholes. The excess adhesive can be displaced inwards to the assigned side face or outwards to the circumferential region via the respective drainage groove and/or the respective overflow groove and/or via the recess in the form of a groove open on one side.

The invention also relates to a humidifier for a vehicle powered by fuel cells for humidifying dry air with humid air. In particular, the humidifier can be designed for a fuel cell system with a fuel cell. The dry air can then be the air flowing to the fuel cell and the humid air the air flowing from the fuel cell. The humidifier has a housing and the membrane stack unit described above. The membrane stacking unit is accommodated in the housing and the side faces of the membrane stack are at least partially sealed from each other inside the housing by the two sealing frames. The two sealing frames can seal against the housing or further seals can be arranged between the housing and the two sealing frames. This allows the respective side faces of the membrane block through which air can flow to be separated from each other in an airtight manner within the housing. If the membrane stack has the sealing plates, the sealing plates can also seal against the housing. In order to avoid repetitions, reference is made here to the above explanations.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements. The elements that are not directly visible are marked with broken lines.

### BRIEF DESCRIPTION OF THE DRAWINGS

These show, schematically in each case, in

FIG. 1 a sectional view of a humidifier according to the invention with labeled air flow;

FIG. 2 an exploded view of a membrane stacking unit according to the invention for the humidifier according to the invention;

FIG. 3 a view of a membrane block of the membrane stacking unit according to the invention;

FIG. 4 a view of a sealing frame of the membrane stacking unit according to the invention in a first embodiment;

FIG. 5 a view of the sealing frame of the membrane stacking unit according to the invention in a second embodiment;

FIG. 6 a sectional view of the membrane stacking unit according to the invention with the sealing frame in a third embodiment;

FIG. 7 a sectional view of the membrane stacking unit according to the invention with the sealing frame in a fourth embodiment without the membrane stack;

FIG. 8 a sectional view of the membrane stacking unit according to the invention with the sealing frame in a fourth embodiment with the membrane stack.

### DETAILED DESCRIPTION

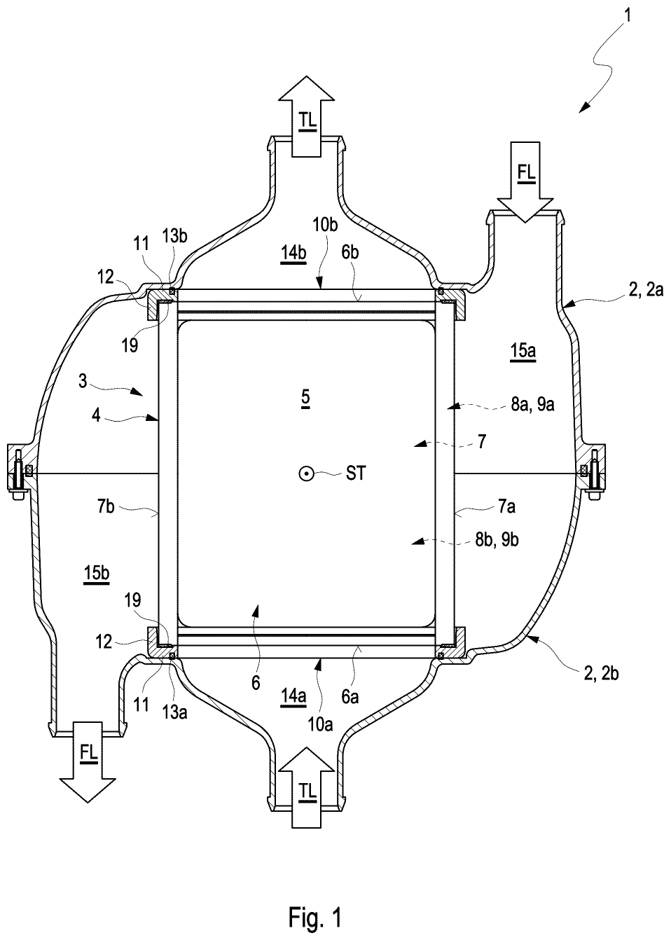

FIG. 1 shows a sectional view of a humidifier 1 according to the invention, in particular for a fuel cell system. The humidifier 1 has a two-part housing 2 and a membrane stacking unit 3 according to the invention. The membrane stacking unit 3 is accommodated in the housing 2.

The membrane stacking unit 3 has a cuboid membrane stack 4 consisting of several flexible membranes 5. The membranes 5 are stacked at a distance from one another in a stacking direction ST, for which purpose spacers or spacers through which air can flow—not shown here—can be arranged between the individual membranes 5. The membranes 5 are glued together in such a way that several ducts 6 and 7 through which air can flow are formed between the membranes 5. The membrane stack 4 thus has four side faces 6a, 6b, 7a, 7b, which are arranged parallel to the stacking direction ST and through which air can flow, and two end faces 8a, 8b, which are aligned transversely to the stacking direction ST and through which air cannot flow—not directly visible here and only indicated.

The respective side faces 6a and 6b are arranged opposite each other and connected to each other by the respective ducts 6 so that they conduct air. In contrast, the respective side faces 6a and 6b are separated from the ducts 7 in an airtight manner. The respective side faces 7a and 7b are arranged opposite each other in the same way and are connected to each other by the respective ducts 7 so that they conduct air. The respective side faces 7a and 7b are appropriately separated from the ducts 6 in an airtight manner. The ducts 6 and 7 alternate in the stacking direction ST, so that a dry air TL and a humid air FL can flow through the membrane stack 4 without mixing in a cross flow.

The dry air TL flows through the ducts 6 and the humid air FL flows through the ducts 7. The membranes 5 are impermeable to air and permeable to humidity or water vapor, so that the dry air TL and the humid air FL can exchange humidity or water vapor with each other through the membranes 5. The end faces 8a and 8b of the membrane stack 4 are formed by two sealing plates 9a and 9b—not directly visible here and only indicated—which are tightly connected to the last membranes 5 in the stacking direction ST. The sealing plates 9a and 9b can, for example, be glued to the last membranes 5 in the stacking direction ST.

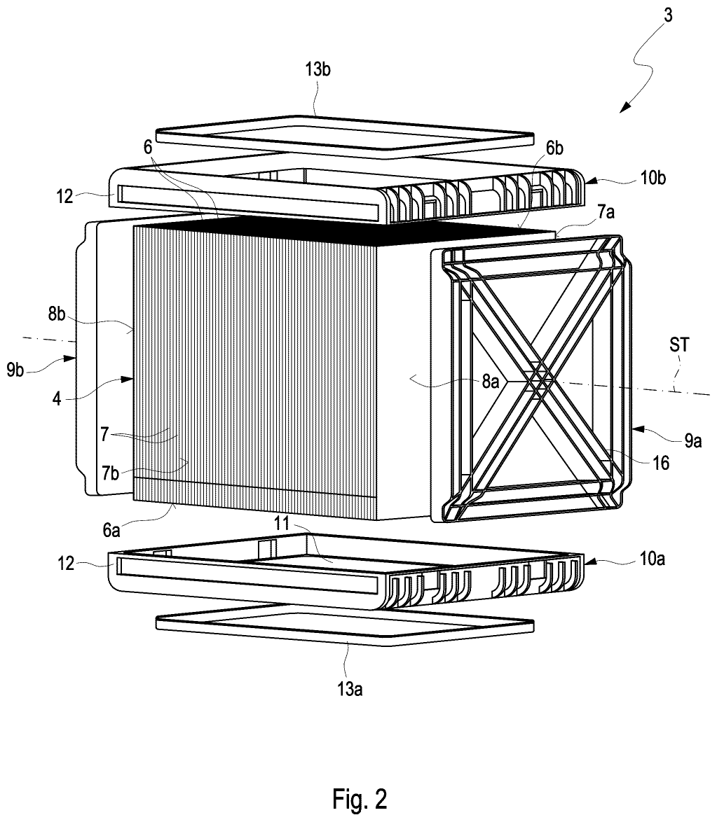

In addition, the membrane stacking unit 3 comprises two sealing frames 10a and 10b, which in this exemplary embodiment are assigned to the side faces 6a and 6b through which the dry air TL flows. However, it is understood that the sealing frames 10a and 10b can also be assigned in the same way to the side faces 7a and 7b through which the humid air FL flows. The respective sealing frames 10a and 10b each have a sealing region 11 and a circumferential region 12, which are aligned perpendicular to each other. As a result, the respective sealing frames 10a and 10b have an approximately L-shaped cross-section. The respective sealing frames 10a and 10b are glued to the membrane stack 4 on the respective assigned side faces 6a and 6b, as explained in more detail in FIG. 2 through FIG. 8.

The sealing region 11 of the respective sealing frame 10a or 10b is frame-shaped and runs around the edge of the assigned side face 6a or 6b. The sealing frame 10a or 10b is glued to the assigned side face 6a or 6b on the sealing region 11 by means of an adhesive 19. The circumferential region 12 is integrally formed on the sealing region 11 and protrudes towards the membrane block 4. The circumferential region 12 runs around the edge of the membrane block 4.

Furthermore, the membrane stacking unit 3 comprises two circumferential seals 13a and 13b, which are clamped in a sealing manner between the respective sealing frames 10a and 10b or between the sealing regions 11 of the respective sealing frames 10a and 10b and the housing 2. The sealing frames 10a and 10b and the two seals 13a and 13b separate the two side faces 6a and 6b inside the housing 2 from each other and from the remaining faces of the membrane stack 4 in an airtight manner. The two sealing plates 9a and 9b also ensure that the two side faces 7a and 7b inside the housing 2 are separated from each other in an airtight manner. As a result, the dry air TL and the humid air FL flow in the housing 2 of the humidifier 1 without mixing and can exchange humidity or water vapor with each other within the membrane block 4 via the membranes 5.

The housing 2 is in two parts and has a first housing part 2a and a second housing part 2b. The two housing parts 2a and 2b are connected to each other in an airtight manner. A first inlet 14a and a first outlet 14b for the dry air TL and a second inlet 15a and a second outlet 15b for the humid air FL are formed in the housing 2. The first inlet 14a is assigned to the side face 6a and the first outlet 14b to the side face 6b. Similarly, the second inlet 15a is assigned to the side face 7a and the second outlet 15b to the side face 7b. The sealing frames 10a and 10b, the seals 13a and 13b and the sealing plates 9a and 9b separate the side faces 6a, 6b, 7a, 7b as well as the respective inlets 14a and 15a and the respective outlets 14b and 15b from each other in an airtight manner.

FIG. 2 shows an exploded view of the membrane stacking unit 3 for the humidifier 1 according to the invention. As already described above, the membrane stacking unit 3 has the membrane stack 4 with the multiple membranes 5. FIG. 2 shows in particular the end faces 8a and 8b with the two sealing plates 9a and 9b, through which air cannot flow. The sealing plates 9a and 9b each have a ribbed structure 16, which serves to support the membrane stacking unit 3 and to prevent the membranes from inflating too much, particularly in the central regions. For this purpose, the sealing frames 10a and 10b surround the sealing plates 9a and 9b in an edge region and thus prevent the membrane stack 4 from expanding in the stacking direction ST or in the longitudinal direction. The two sealing frames 10a and 10b, which are glued to the side faces 6a and 6b of the membrane stack 4, are also visible. The two seals 13a and 13b, which seal the membrane stacking unit 3 to the housing 2, are arranged on the sealing frames 10a and 10b.

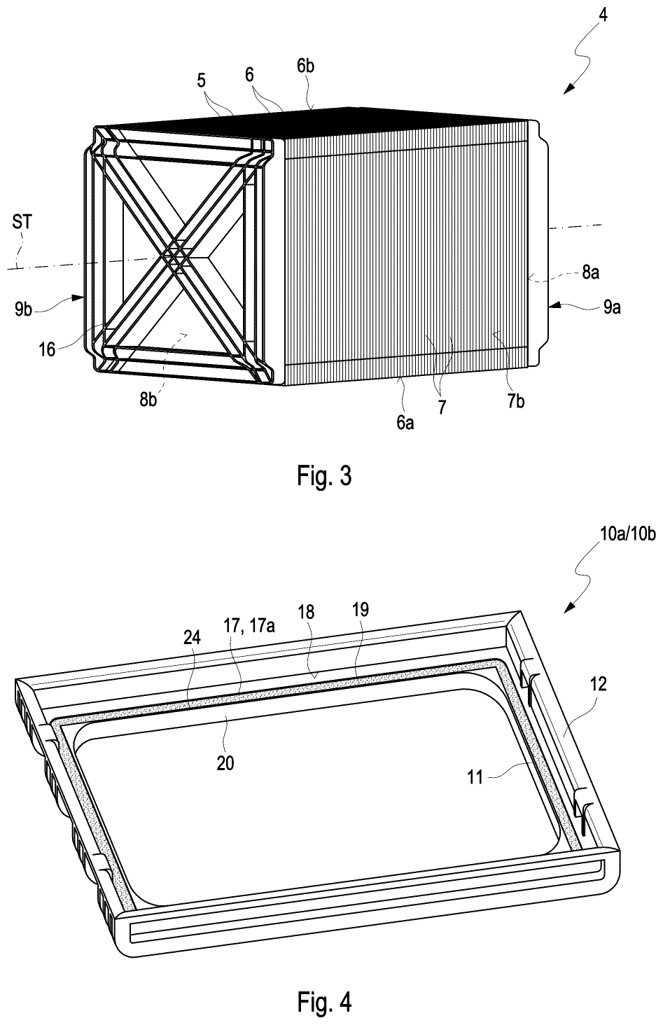

FIG. 3 shows a view of the membrane block 4 of the membrane stacking unit 3 according to the invention. As already described above, the membrane stack 4 has the multiple membranes 5 and the sealing plates 9a and 9b. The individual membranes 5 are glued together and the last membranes 5 in the stacking direction ST are also glued to the sealing plates 9a and 9b. The membrane block 4 thus forms a coherent, inseparable unit.

FIG. 4 shows a view of the sealing frame 10a or 10b of the membrane stacking unit 3 according to the invention in a first embodiment. The sealing frame 10a or 10b has a recess 17 on a surface 18 facing the assigned side face 6a or 6b. The recess 17 is shaped in the form of a groove 17a and runs around the edge of the respective assigned side face 6a or 6b of the membrane stack 4. The recess 17 is formed between an edge 20 of the sealing region 11 opposite the circumferential region 12 and the circumferential region 12. The recess 17 is arranged at a distance from the edge 20 and the circumferential region 12. In other words, the recess 17 is separated from the edge 20 by a web 24. The recess 17 is filled with the adhesive 19 and the respective sealing frame 10a or 10b can be glued to the assigned side face 6a or 6b by means of the adhesive 19.

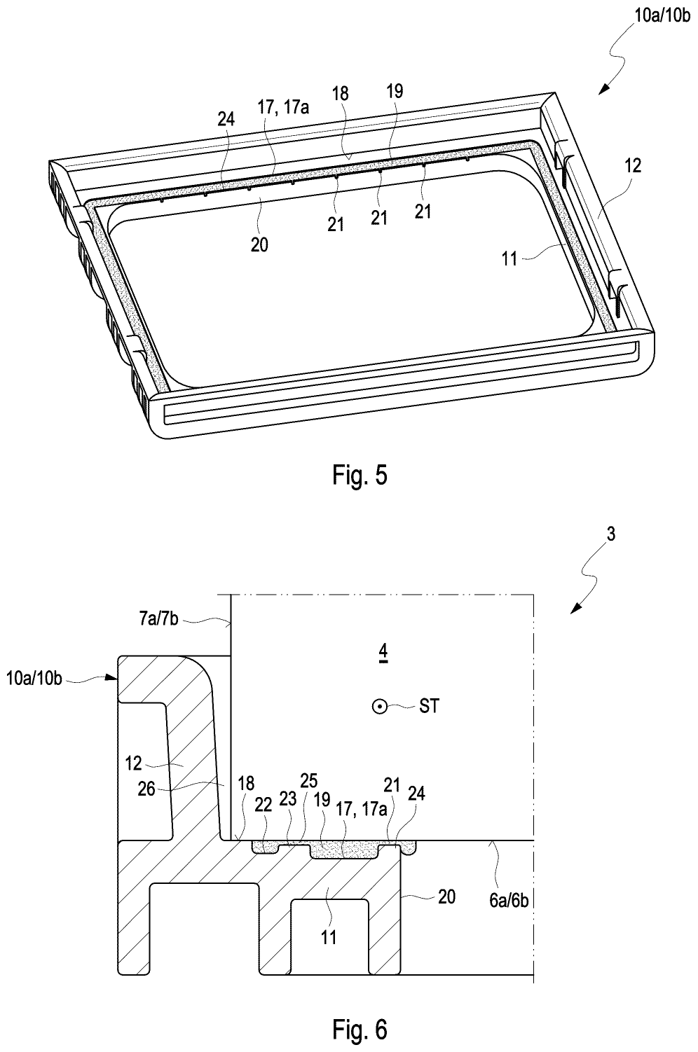

FIG. 5 shows a view of the sealing frame 10a or 10b of the membrane stacking unit 3 according to the invention in a second embodiment. In contrast to the first embodiment of the sealing frame 10a or 10b, the respective sealing frame 10a or 10b here has several drainage grooves 21 which lead from the recess 17—here the groove 17a—to the edge 20 or to the assigned side face 6a or 6b. The drainage grooves 21 are formed in the web 24 formed between the recess 17 and the edge 20. The excess adhesive 19 can be drained via the drainage grooves 21 onto the assigned side face 6a or 6b, so that the recess 17 can be overfilled and the respective sealing frame 10a or 10b can be connected to the assigned side face 6a or 6b without blowholes. Otherwise, the first embodiment and the second embodiment of the respective sealing frame 10a and 10b are identical.

FIG. 6 shows a sectional view of the membrane stacking unit 3 according to the invention with the sealing frame 10a or 10b in a third embodiment. In the third embodiment, the respective sealing frame 10a or 10b has an overflow groove 22 in addition to the recess 17—here the groove 17a—and the several drainage grooves 21. The recess 17 and the drainage grooves 21 are identical to those shown in the second embodiment. The overflow groove 22 is formed between the recess 17 and the circumferential region 12 at a distance from the recess 17 and the circumferential region 12. The overflow groove 22 runs around the respective assigned side face 6a or 6b of the membrane stack 4 or the recess 17. The recess 17 and the overflow groove 22 are appropriately fluidically connected to each other. For this purpose, a web 23 formed between the overflow groove 22 and the recess 17 is formed at a distance from the side face 6a or 6b, so that a gap 25 is formed between the web 23 and the assigned side face 6a or 6b. For this purpose, the web 23 has a correspondingly adapted height. The excess adhesive 19 can escape from the recess 17 via the gap 25 into the overflow groove 22 and/or via the respective drainage grooves 21 onto the assigned side face 7a or 7b.

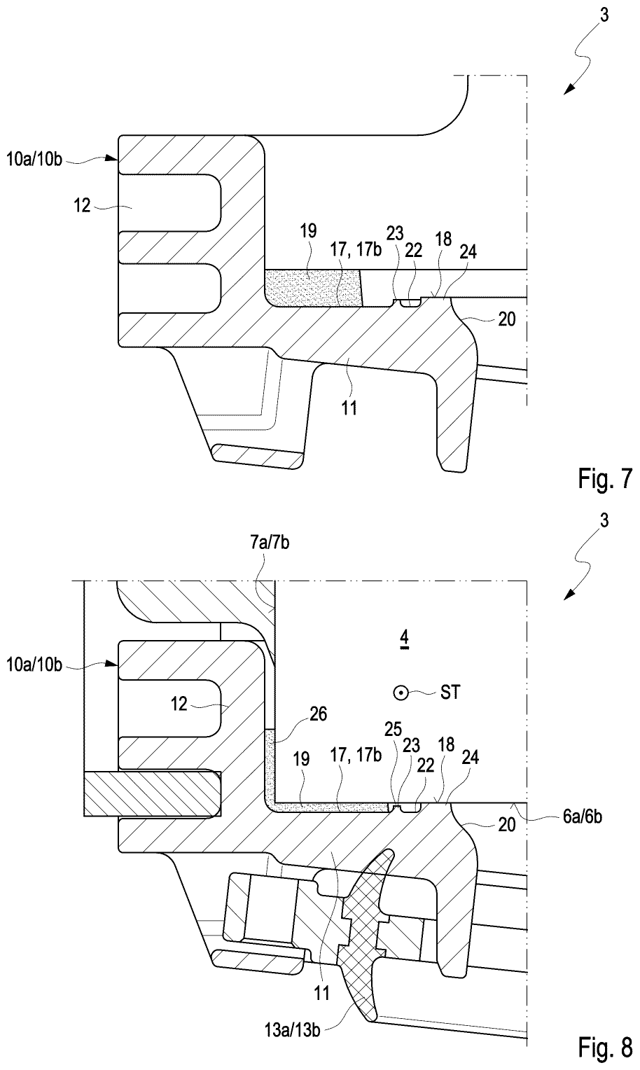

FIG. 7 shows a sectional view of the membrane stacking unit 3 according to the invention with the sealing frame 10a or 10b in a fourth embodiment and without the membrane stack 4. FIG. 8 shows a sectional view of the membrane stacking unit 3 according to the invention with the sealing frame 10a or 10b in a fourth embodiment and with the membrane stack 4. In the fourth embodiment, in contrast to the other embodiments, the recess 17 is shaped in the form of a groove 17b that is open on one side. The groove 17b is closed towards the edge 20 of the sealing region 11 and open towards the circumferential region 12. This allows the excess adhesive 19 to flow from the recess 17 to the circumferential region 12 and further into a gap 26 between the membrane stack 4 and the circumferential region 12. In addition, in the fourth embodiment, the overflow groove 22 is formed between the edge 20 and the recess 17. The fluidic connection between the recess 17 and the overflow groove 22 is formed identically as in the third embodiment.

1. A membrane stacking unit for a humidifier for a vehicle powered by fuel cells, comprising:
a cuboid membrane stack with a plurality of flexible membranes stacked in a stacking direction,
wherein the membrane stack has four side faces through which air can flow and which are aligned parallel to the stacking direction and two end faces through which air cannot flow and which are aligned transversely to the stacking direction,
two sealing frames assigned to two opposing side faces of the membrane stack,
wherein the respective sealing frame has a circumferential sealing region and the sealing region runs around the edge of the respective assigned side face and rests against it,
wherein the respective sealing frame has a circumferential region projecting vertically from the sealing region and the circumferential region faces the membrane stack and runs around the edge of the membrane stack,
wherein the respective sealing frame has, at least on a surface of the sealing region facing the assigned side face, a respective recess running around the assigned side face, and
wherein the respective recess is filled with an adhesive and the respective sealing frame is sealed to the membrane stack via the adhesive.

2. The membrane stacking unit according to claim 1, wherein the respective recess is formed by a groove, wherein the groove is at a distance from an edge of the sealing region opposite the circumferential region.

3. The membrane stacking unit according to claim 1, wherein the respective recess is formed by a groove open on one side, wherein the groove is delimited from an edge of the sealing region opposite the circumferential region by a web and being open towards the circumferential region.

4. The membrane stacking unit according to claim 1, wherein:
the respective sealing frame has at least one drainage groove for draining the excess adhesive from the respective recess and the at least one drainage groove is fluidically connected to the respective recess, and
the at least one drainage groove leads from the respective recess to an edge of the sealing region opposite the circumferential region and onto the side face of the membrane stack.

5. The membrane stacking unit according to claim 1, wherein:
the respective sealing frame has at least one drainage groove for draining excess adhesive from the respective recess and the at least one drainage groove is fluidically connected to the respective recess, and
the at least one drainage groove leads from the respective recess to the circumferential region of the sealing frame and to a gap located between the membrane stack and the circumferential region.

6. The membrane stacking unit according to claim 1, wherein:
the respective sealing frame has at least one overflow groove running around the assigned side face, and
the at least one overflow groove on the surface of the sealing region facing the assigned side face is shaped at a distance from the respective recess and is fluidically connected to the respective recess.

7. The membrane stacking unit according to claim 6, wherein:
the at least one overflow groove is located between the respective recess and an edge of the sealing region of the sealing frame opposite the circumferential region, or
the at least one overflow groove is located between the recess and the circumferential region of the sealing frame.

8. The membrane stacking unit according to claim 6, further comprising:
a web disposed between the respective recess and the at least one overflow groove, wherein the web is spaced apart from the assigned side face and a gap is disposed between the web and the assigned side face, and wherein the respective recess and the at least one overflow groove are fluidically connected to one another via the gap, and/or
a web disposed between the respective recess and the at least one overflow groove and at least one connecting groove is formed in the web, wherein the respective recess and the at least one overflow groove are fluidically connected to one another via the at least one connecting groove.

9. The membrane stacking unit according to claim 1, wherein:
the respective recess has at least two sections with differing heights and/or differing widths, and/or
at least one overflow groove has at least two sections with differing heights and/or differing widths.

10. A humidifier for a vehicle powered by fuel cells for humidifying a dry air with a humid air, comprising:
a housing and a membrane stacking unit, the membrane stacking unit including:
a cuboid membrane stack with a plurality of flexible membranes stacked in a stacking direction,
wherein the membrane stack has four side faces through which air can flow and which are aligned parallel to the stacking direction and two end faces through which air cannot flow and which are aligned transversely to the stacking direction,
two sealing frames assigned to two opposing side faces of the membrane stack,
wherein the respective sealing frame has a circumferential sealing region and the sealing region runs around the edge of the respective assigned side face and rests against it,
wherein the respective sealing frame has a circumferential region projecting vertically from the sealing region and the circumferential region faces the membrane stack and runs around the edge of the membrane stack, the respective sealing frame has, at least on a surface of the sealing region facing the assigned side face, a respective recess running around the assigned side face,
wherein the respective recess is filled with an adhesive and the respective sealing frame is sealed to the membrane stack via the adhesive, and
wherein the membrane stacking unit is accommodated in the housing and the side faces of the membrane stack within the housing are at least partially sealed from one another by the two sealing frames.

11. The humidifier according to claim 10, wherein the respective recess is formed by a groove, wherein the groove is at a distance from an edge of the sealing region opposite the circumferential region.

12. The humidifier according to claim 10, wherein:
the respective sealing frame has at least one drainage groove for draining excess adhesive from the respective recess and the at least one drainage groove is fluidically connected to the respective recess, and
the at least one drainage groove leads from the respective recess to an edge of the sealing region opposite the circumferential region and onto the side face of the membrane stack.

13. The humidifier according to claim 10, wherein the respective recess is formed by a groove open on one side, wherein the groove is delimited from an edge of the sealing region opposite the circumferential region by a web and being open towards the circumferential region.

14. The humidifier according to claim 10, wherein:
the respective sealing frame has at least one drainage groove for draining excess adhesive from the respective recess and the at least one drainage groove is fluidically connected to the respective recess, and
the at least one drainage groove leads from the respective recess to the circumferential region of the sealing frame and to a gap located between the membrane stack and the circumferential region.

15. The humidifier according to claim 10, wherein:
the respective sealing frame has at least one overflow groove running around the assigned side face, and
the at least one overflow groove on the surface of the sealing region facing the assigned side face is shaped at a distance from the respective recess and is fluidically connected to the respective recess.

16. The humidifier according to claim 15, wherein the at least one overflow groove is located between the respective recess and an edge of the sealing region of the sealing frame opposite the circumferential region.

17. The humidifier according to claim 15, wherein the at least one overflow groove is located between the recess and the circumferential region of the sealing frame.

18. The humidifier according to claim 15, further comprising a web disposed between the respective recess and the at least one overflow groove, wherein the web is spaced apart from the assigned side face and a gap is disposed between the web and the assigned side face, and wherein the respective recess and the at least one overflow groove are fluidically connected to one another via the gap.

19. The humidifier according to claim 15, further comprising a web disposed between the respective recess and the at least one overflow groove and at least one connecting groove is formed in the web, wherein the respective recess and the at least one overflow groove are fluidically connected to one another via the at least one connecting groove.

20. The humidifier according to claim 10, wherein the respective recess has at least two sections with differing heights and/or differing widths.
